(19) United States
(12) Patent Application Publication
(10) Pub. No.: US 2014/0102247 A1
(43) Pub. Date: Apr. 17, 2014

(54) CONNECTING ROD FOR REFRIGERATION COMPRESSORS

(71) Applicants: Fabiano Domingos Silva, Joinville - Sc (BR); Gelson Longo, Joinville - Sc (BR)

(72) Inventors: Fabiano Domingos Silva, Joinville - Sc (BR); Gelson Longo, Joinville - Sc (BR)

(73) Assignee: WHIRLPOOL S.A., São Paulo -Sp (BR)

(21) Appl. No.: 14/113,699

(22) PCT Filed: Apr. 25, 2012
(86) PCT No.: PCT/BR2012/000119

§ 371 Date: Dec. 27, 2013

(30) Foreign Application Priority Data
Apr. 26, 2011 (BR) PI1101929-8

(51) Int. Cl. F16C 7/02

(52) U.S. Cl. CPC F16C 7/02
USPC 74/581

(57) ABSTRACT

The compressors of the invention comprise: a crankcase carrying a cylinder, inside which is lodged a piston provided with two radial holes and with one eccentric axial hole; a connecting rod having a smaller eye mounted in the interior of the piston and connected to a larger eye through a rod; a wrist pin provided with a diametral hole and disposed through the smaller eye of the connecting rod and through the opposite radial holes of the piston; and an elastic pin to be inserted in the eccentric axial hole of the piston and in the diametral hole of the wrist pin. The connecting rod incorporates an indexing stop which defines an axial seating surface for a tool for inserting the elastic pin, said axial seating surface being positioned at a predetermined distance from the axis of the smaller eye of the connecting rod.

### FIELD OF THE INVENTION

The present invention refers to a connecting rod for refrigeration compressors, of the reciprocating type, used in small household and commercial refrigeration systems and which comprise, in the interior of a shell, a crankcase which defines a cylinder, inside which reciprocates a piston, and a bearing hub, in which is supported a crankshaft incorporating an eccentric portion and carrying a rotor of an electric motor, whose stator is affixed to the crankcase. The connecting rod of the present invention comprise, in a single piece, a rod or web connecting a larger eye, mounted around the eccentric portion of the crankshaft, and a smaller eye which is affixed to a pin internal to the piston, so that the connecting rod can reciprocate the piston in the interior of the cylinder, when the crankshaft is rotated by the electric motor.

### PRIOR ART

It has been continuous the search for solutions aiming at increasing the energy efficiency of the reciprocating compressors used in small household and commercial refrigeration systems. One of the ways to increase energy efficiency is to reduce the mechanical losses of the movable components, such as those produced by the relative movement between the surfaces of a tribological pair. Said mechanical losses refer to the losses by contact and to the losses by viscous friction between the surfaces of the tribological pair. However, it should be understood that the ,coefficient of dynamic friction, produced by the lubricated contact between two surfaces is, at minimum, one order of magnitude higher than the coefficient of viscous friction in a thick film regime, for metallic components with conventional finishings by grinding and/or burnishing, as it occurs with the mutually confronting surfaces of the piston and cylinder and also of other relatively moving and frictioning components of the compressor, for example between the crankshaft and the bearings.

Mainly in the first operating hours, there occurs a considerable amount of mechanical loss, due to friction generated by the mutual contact of said surfaces, resulting from inadequate surface finishings, great shape errors, or even undersizing of the bearings. Depending on the intensity of said contact under friction, there may occur a degeneration of the surfaces (mechanical, geometric and surface finishing properties), leading to failure of the bearings by wear.

One of the development lines for compressors with high energy efficiency is directed to the improvement of the geometric quality of the components used, mainly the geometric quality of the assembly of said components. Said development line takes care of the errors of centralization (for example, concentricity, co-axiality, etc.); errors of shape (for example, circularity, cylindricity, impacts; planeness, etc.) and errors of position (for example, parallelism, perpendicularism, etc.)

In the refrigeration reciprocating compressors, of the type considered herein, the piston is coupled to the smaller eye of the connecting rod by means of a wrist pin, transversal to the axis of the piston and which has its opposite end portions introduced and retained in respective radial holes provided in the piston, in diametrically opposite positions.

In some compressor models, the fixation of the wrist pin to the piston is made by interference fitting between one of the end portions of the wrist pin and one of the diametrically opposite radial holes of the piston. Nevertheless, the higher the degree of interference between the wrist pin and the piston for guaranteeing the reliable fixation of said pin, the higher will be the degree of deformation (by error of circularity and cylindricity) produced on the cylindrical surface of the piston, that is, on its bearing surface.

One of the known ways to minimize the deformations resulting from a fixation, by interference, between the wrist pin and the piston, is the one which uses a wrist pin mounted, without interference, in the diametrically opposite holes of the piston. In this case, the retention of the wrist pin is obtained by an elastic pin which is loosely guided into an eccentric axial hole provided in the piston wall, and affixed, by interference, in at least part of the diametral extension of a respective end portion of the wrist pin.

In this known solution, the absence of an interference fit between the wrist, pin and the piston does not add errors of circularity and cylindricity of the piston in relation to the possible shape errors or deviations resulting from the grinding and/or burnishing operations of the lateral surface of the piston.

Besides the benefit mentioned above, the fixation of the wrist pin by means of an elastic pin also presents the advantage of allowing the mounting of the smaller eye of the connecting rod (usually in a single piece), in the interior of the piston, to be the last step in the mounting operation (closing) of the components of the mechanical kit of the compressor.

This known mounting farm (closing) of the mechanical kit is usually preferred in relation to other forms which comprise:
using connecting rods made of two pieces, that is, divided in the rod (web) or in the larger eye;
using bushings mounted between the larger eye and the eccentric portion of the crankshaft;
affixing, through bolts, the bearing hub of the crankshaft to the compressor crankcase;
affixing, to the compressor crankcase and through bolts, a crankcase portion which defines the cylinder.

It should be noted that the use of a single-piece connecting rod is advantageous in terms of increasing the energy efficiency of the compressor, since the connecting rod is used in its final manufacturing form (by sintering or by machining), which avoids introducing additional geometric errors of shape and position to the mounted component.

The use of an elastic pin for fixation of the wrist pin, together with the use of a single-piece connecting rod, requires the provision of a slot along part of the lateral wall of the cylinder, in opposition to the crankcase, in order to allow mounting the wrist pin to the piston, through the smaller eye of the single-piece connecting rod, which smaller eye is already housed in the interior of the piston already mounted in the interior of the cylinder. Solutions of this type can be seen in documents U.S. Pat. No. 4,406,590 and U.S. Pat. No. 5,730,044.

Presently, one of the greatest challenges of the solutions that use an elastic pin to retain the wrist pin in the opposite radial holes of the piston is to carry out the mounting of the elastic pin so as to guarantee its correct positioning in relation to the wrist pin, in order to avoid, upon operation of the compressor during its useful life, the release or breakage of the elastic pin, causing the compressor to stop by the sticking of its driving mechanism.

The elastic pin is the last component of the mechanical kit to be mounted. In said solution, the single-piece connecting rod has its larger eye mounted around the eccentric portion of the crankshaft and its smaller eye housed in the interior of the cylinder, after passing through the longitudinal lateral slot of the latter. The piston is then introduced in the interior of the cylinder, so as to have its opposite radial holes axially aligned with the axis of the smaller eye of the single-piece connecting rod, allowing mounting the wrist pin in the opposite radial holes of the piston and through the smaller eye of the connecting rod, the wrist pin being positioned so that its diametral hole, adjacent to the end turned to the longitudinal lateral slot of the cylinder, remains axially aligned with an eccentric axial hole of the piston, open to the end of the skirt of the latter. Then, the elastic pin can be mounted through the eccentric axial hole of the piston, preferably without interference, and through the diametral hole of the wrist pin, under interference.

For mounting the elastic pin, it is necessary to apply an insertion axial force by means of an adequate tool, which insertion axial force should be greater than the reaction axial force caused by the interference between the outer diameter of the elastic pin and the inner diameter of the diametral hole of the wrist pin.

The elastic pin usually presents a longitudinally split tubular form, in order to allow its elastic radial deformation when mounted through the diametral hole of the wrist pin, the dimensioning of the elastic pin being made so as to guarantee an interference with the wrist pin, sufficient to provoke the adequate and reliable retention of the elastic pin in its mounting position during the useful operative life of the compressor. The elastic pin is axially displaced from its mounting position only when an extraction force is applied thereto.

The tool for inserting the elastic pin can be seated on any one of the components of the mechanical kit defined, for example, by the crankshaft, piston, connecting rod, or by the crankcase, provided that said support means can support, without causing damages (breaks, dents, etc.), the reaction force that is applied against both the elastic pin and the tool, by the degree of mechanical interference between the elastic pin and the diametral hole of the wrist pin.

As it is known, one of the more usual ways to alter the refrigeration capacity of a compressor, of the type considered herein, is by altering the eccentricity of the crankshaft, that is, the radial distance between the axis of the crankshaft and the axis of its eccentric portion around which is mounted the larger eye of the connecting rod. The alteration of the eccentricity produces different volumes of refrigerant gas displaced by the piston in the interior of the cylinder. Therefore, it is also necessary to alter the distance between the top of the piston and the common axis of its two opposite radial holes and, sometimes, the distance between the larger eye and the smaller eye of the connecting rod.

Considering the dimensional variations mentioned above, which are found in different models of refrigeration compressors of the type considered herein, the distance between a support surface for the insertion tool and the confronting end of the elastic pin will also vary as a function of the dimensional alterations found between the different models of said compressors to be produced in the same assembly line.

Thus, it is necessary to submit the assembly line to long setup (adjustment) operations whenever some dimensional variation is found in the components of the compressor which can affect the distance between the seating surface of the insertion tool and the confronting end of the elastic pin. Failing to execute the necessary adjustments in the displacement of the insertion tool can cause breakage of the elastic pin or its incomplete insertion, allowing said elastic pin to fall during the useful operative life of the compressor.

### SUMMARY OF THE INVENTION

As a function of the inconveniences mentioned above, related to the necessary long adjustments to be frequently made in the assembly line of different models of refrigeration compressors of the type considered herein, in order to promote an adequate and reliable insertion of the elastic pin in the diametral hole of the wrist pin, the present invention has the object of providing a constructive solution which is capable of maintaining, at a constant value, the travel of the axial displacement of the insertion tool of the elastic pin, for a wide range of compressor models presenting different eccentricities, different lengths of connecting rods, or different distances between the piston top and the axis of the wrist pin.

It is a more specific object of the present invention to provide a support means for the insertion tool, which maintains a constant distance from the confronting end of the elastic pin in the inserted condition through the diametral hole of the wrist pin.

These and other objects of the present invention are attained when applied to a refrigeration compressor of the type which comprises: a crankcase, carrying a cylinder; a piston reciprocating in the interior of the cylinder and provided with two diametrically opposite radial holes, and with an eccentric axial hole; a single-piece connecting rod, having a smaller eye mounted in the interior of the piston and connected to a larger eye by a rod; a wrist pin, disposed through the smaller eye of the connecting rod and through the opposite radial holes of the piston, said wrist pin being provided with a diametral hole axially aligned with the eccentric axial hole of the piston; and an elastic pin, to be inserted in the eccentric axial hole of the piston and in the diametral hole of the wrist pin.

According to the invention, the connecting rod incorporates an indexing stop, presenting an axial seating surface for a tool for inserting the elastic pin in the interior of the diametral hole of the wrist pin, said axial seating surface being positioned at a predetermined distance from the axis of the smaller eye of the connecting rod.

The construction proposed by the invention and defined above, allows maintaining, always constant, the insertion travel of the elastic pin in the diametral hole of the wrist pin, for a wide range of compressor models, presenting different distances between the two eyes of the connecting rod, different eccentricities in the eccentric portion of the crankshaft, and different distances between the top of the piston and the axis of its radial holes. Moreover, the elastic pin can be maintained with the same length for said range of compressor models.

### BRIEF DESCRIPTION OF THE DRAWINGS

The invention will be described below, with reference to the appended drawings, in which:

FIG. 1 represents, in a partial vertical sectional view, a refrigeration compressor comprising a crankcase carrying a cylinder, a piston reciprocating in the interior of the cylinder, a crankshaft supported by the crankcase and having an eccentric portion which is connected to the piston by means of a single-piece connecting rod and of a wrist pin, said crankcase affixing a stator of an electric motor, whose rotor is affixed to the crankshaft;

FIG. 2 represents a perspective view of a single-piece connecting rod, constructed according to one of the possible embodiments of the invention; and

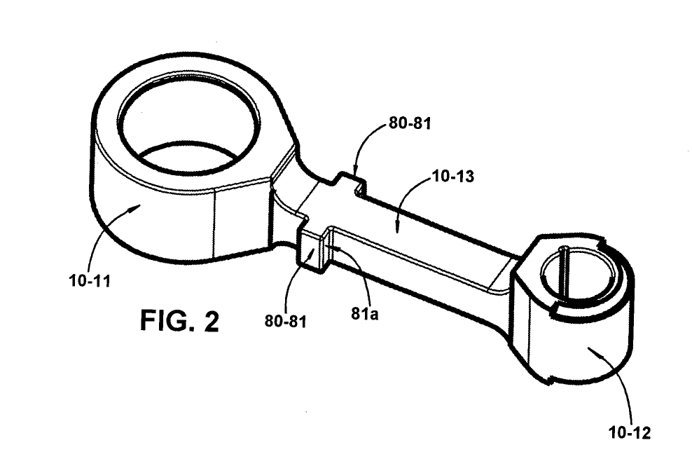

FIG. 3 represents an upper plan view of the single-piece connecting rod, already mounted to the crankshaft and to the piston, said view being taken according to line in FIG. 1, intersecting the piston and illustrating the elastic pin in the position in which it is inserted through the diametral hole of the wrist pin.

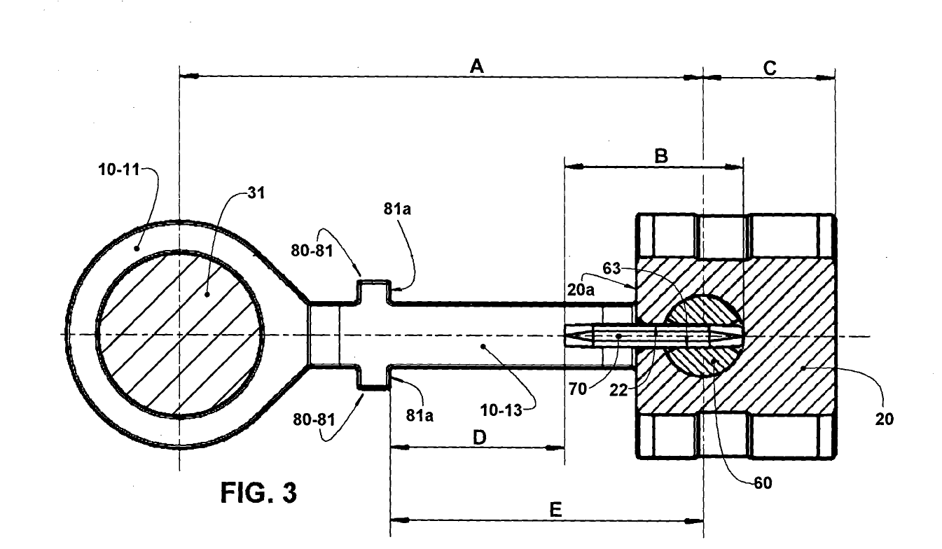

### DESCRIPTION OF THE INVENTION

As illustrated and previously described, the present connecting rod 10 is of the single-piece type, having a larger eye 11 mounted around an eccentric portion 31 of a crankshaft 30 of a refrigeration compressor, and a smaller eye 12 to be coupled to a piston 20 of the compressor, said eyes being interconnected by a rod 13. The refrigeration compressor, to which the present connecting rod is designed to be applied, can be of the type which comprises a crankcase 40, which defines a cylinder 41, inside which the piston 20 is displaced by the connecting rod 10, in a reciprocating movement, when the crankshaft 30 is driven by an electric motor 50, which has its rotor 51 affixed to the crankshaft 30 and its stator 52 affixed to the crankcase 40, around the rotor 51.

The coupling of the smaller eye 12 of the connecting rod 10 to the piston 20 is obtained by means of a generally massive wrist pin 60. Said wrist pin 60 has its opposite end portions introduced, without interference, and retained in respective diametrically opposite radial holes 21 of the piston 20, and its median portion disposed through the smaller eye 12 of the connecting rod 10.

In this type of compressor construction, the cylinder 41 is provided with a lateral slot 42, which is longitudinally disposed in the region of the cylinder 41 disposed in opposition to the crankcase 40, that is, the region turned to the side of the crankcase 40 opposite to that side to which the stator 52 of the electric motor 50 is affixed.

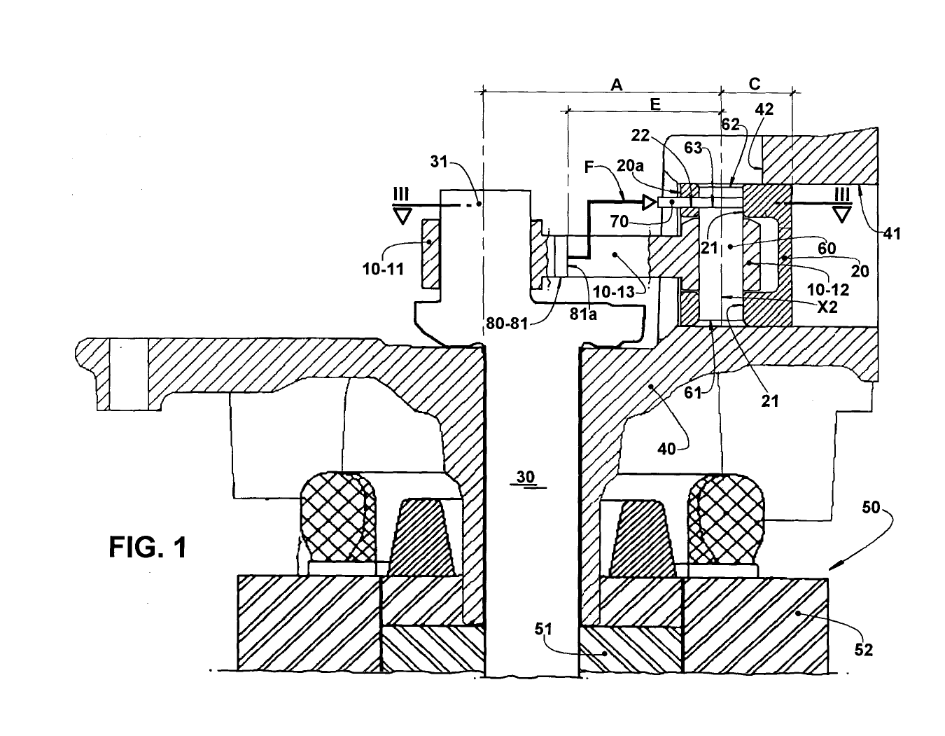

As illustrated in FIG. 1, the lateral slot 42 allows mounting the single-piece connecting rod 10 in the interior of the piston 20 already positioned in the interior of the cylinder 41, in the lower dead point position, at the end of the suction stroke. Said known construction allows the wrist pin 60 to have a first end introduced through: the lateral slot 42 of the cylinder 41, the adjacent radial hole 21 of the piston 20, the smaller eye 12 of the connecting rod 10, and through the interior of the opposite radial hole 21 of the piston 20, until reaching the correct axial position of the wrist pin 60 in the piston 20, with a second end 62 of the wrist pin 60 being operatively associated with a mounting tool (not illustrated) and positioned, at the end of mounting axial travel inside the radial hole 21 of the piston 20, as illustrated in FIG. 1.

As mentioned at the beginning of the present disclosure, the wrist pin 60 has its opposite end portions introduced, without mechanical interference, into the respective radial holes 21 of the piston 20. Thus, it is necessary to axially retain the wrist pin 60 in the radial holes 21 of the piston 20.

The constructive solution used in the present invention is of the type which provides an eccentric axial hole 22 in the lateral wall 20a of the piston 20, which eccentric axial hole 22 diametrically crosses the radial hole 21 of the piston 20, which radial hole 21 is turned to the lateral slot 42, upon mounting the piston 20 in the cylinder 41. In this eccentric axial hole 22 is introduced, with little or no interference, an elastic pin 70 which diametrically crosses the adjacent radial hole 21 of the piston 20.

The wrist pin 60 is provided with a diametral through hole 63 which is disposed near the second end of the wrist pin 60, so as to be axially aligned with the eccentric axial hole 12 of the piston 10, upon the final positioning of the wrist pin 60 in relation to the piston 10. In this condition, the elastic pin 70 can be introduced into the eccentric axial hole 22 of the piston and through the diametral hole 63, guaranteeing the axial and rotational retention of the wrist pin 60 in its final and correct positioning in the piston 20. Generally, the elastic pin 70 presents a longitudinally slotted tubular shape, in order to allow its elastic radial deformation when mounted, by insertion, through the diametral hole 63 of the wrist pin 60.

The elastic pin 70 is introduced through the eccentric axial hole 22 of the piston 20 preferably with no mechanical interference, the axial retention of the elastic pin 70 being guaranteed by introducing it, with interference, through the diametral hole 63 of the wrist pin 60. Thus, there is obtained a reliable axial retention of the elastic pin 70 to the wrist pin 60, without applying any relevant deforming force in the skirt region of the piston 20. The elastic pin 70 is only axially displaced from its final mounting position by application of an extraction force thereto.

It should be understood that the elastic pin 70 can be introduced through the eccentric axial hole 12 of the piston 20 also with a certain degree of interference, which is insufficient to cause harmful deformations to the skirt region of the piston 20, but sufficient to increase even more the degree of axial retention of the elastic pin 70 in the piston-wrist pin assembly.

As previously mentioned, for mounting the elastic pin 70, it is necessary to apply an insertion axial force by means of an adequate tool F, which insertion axial force should be greater than the reaction axial force caused by the interference between the outer diameter of the elastic pin 70 and the inner diameter of the diametral hole 63 of the wrist pin 60.

According to the invention, the connecting rod 10 is provided with an indexing stop 80, which is configured to allow the tool F to be seated and retained thereon, as schematically illustrated in FIG. 1.

In the illustrated embodiment, the indexing stop 80 takes the form of a pair of projections 81, incorporated in opposite lateral sides of the rod 13 of the connecting rod 10 and each defining an axial seating surface 81a positioned at a predetermined distance E in relation to the axis X2 of the smaller eye 12 of the connecting rod 10. It should be understood that the pair of projections 81 may be substituted by a single projection projecting from the rod 13 in a direction transversal to the longitudinal axis of the latter, adequate to the reliable and precise indexed axial seating of the tool F.

The indexing stop 80 can take different forms and be incorporated in different positions in the connecting rod 10, provided that it defines an axial seating surface 81a for the tool F which inserts the elastic pin 70, allowing said tool F to act in an axial form in relation to the eyes 11, 12 of the connecting rod 10, supporting the insertion force of the elastic pin 70, without damaging the components of the driving mechanism of the compressor.

The shape of the axial seating surface 81a of the indexing stop 80 should be compatible with that of the confronting part of the tool F, so that the latter can be easily and reliably seated against the axial seating surface 81a during the automated operation of inserting the elastic pin 70 in an assembly line of the compressors.

In the case the indexing stop 80 takes the form of a projection (not illustrated) superiorly incorporated to the rod 13 of the connecting rod 10, the distance E, between the axial seating surface of said upper projection (not illustrated) and the axis X2 of the smaller eye 12 of the connecting rod 10, should be preferably larger than the difference between the length B of the elastic pin 70 and half the diameter of the wrist pin 60 in the region of the diametral hole 63, so that the tool F can have one part of its structure seated, without great constructive or operational complications, on the axial seating surface of the upper projection, and another part axially acting against the confronting end of the elastic pin 70, during the insertion process of the latter.

However, in the illustrated construction, in which the two projections 81 are laterally incorporated to the rod 13 of the connecting rod 10, the above-mentioned dimensional relation need not be taken into account. According to the invention, the tool F for inserting the elastic pin 70 will be always seated on an axial seating surface 81a of the connecting rod 10, presenting a constant distance E in relation to axis X2 of the smaller eye 12, independently of the distance A between the two eyes 11, 12 of the connecting rod 10, of the eccentricity of the eccentric portion 31 of the crankshaft 30, of the distance C between the top of the piston 20 and the axis of its radial holes 21, and allowing the use of an elastic pin 70, whose length need not be specifically dimensioned for each compressor model, that is, the same length of the elastic pin 70 can be used in a wide range of compressor models.

With the constructive solution proposed by the present invention, the dimensional variation admitted by the tolerances of the manufacturing process of the mechanical components involved will depend only on two dimensions, namely: the distance E between the indexing stop 80 and the axis X2 of the smaller eye 12; and the length B of the elastic pin 70. Since these dimensions present excellent dimensional stability, the proposed solution allows controlling, in the assembly line, the distance D between the indexing stop 80 and the confronting end of the elastic pin 70, with a relatively small tolerance range.

Thus, the assembly line need not suffer long adjustment operations, whenever a small dimensional variation appears in the components of the compressor, which may affect the distance between the axial seating surface 81a of the insertion tool F and the axis X2 of the smaller eye 12 of the connecting rod 10.

Another advantage resulting from the present constructive solution is to allow controlling the insertion force of the elastic pin 70 in the same relative position between the latter and the wrist pin 60, filtering eventual manufacturing errors of the outer diameter of the elastic pin 70 or of the diameter of the diametral hole 63 of the wrist pin 60, with a smaller range of tolerance for accepting the minimum and maximum limits of said insertion force. Such control of the insertion force can be achieved by the use transducers in a known arrangement in the tool F for insertion of the elastic pin 70.

While only one possible embodiment for the indexing stop 80 has been illustrated herein, it should be understood that different constructive forms for said indexing stop can be used, without escaping from the inventive concept defined in the claim set of the present disclosure.

1. A connecting rod for refrigeration compressors of the type which comprises: a crankcase carrying a cylinder; a piston reciprocating in the interior of the cylinder and provided with two diametrically opposite radial holes and with one eccentric axial hole; a single-piece connecting rod having a smaller eye mounted in the interior of the piston and connected to a larger eye through a rod; a wrist pin disposed through the smaller eye of the connecting rod and through the opposite radial holes of the piston, said wrist pin being provided with a diametral hole axially aligned with the eccentric axial hole of the piston; and an elastic pin to be inserted in the eccentric axial hole of the piston and in the diametral hole of the wrist pin, said connecting rod being characterized in that it incorporates an indexing stop presenting an axial seating surface for a tool for insertion of the elastic pin in the interior of the diametral hole of the wrist pin, said axial seating surface being positioned at a predetermined distance from the axis of the smaller eye of the connecting rod.

2. The connecting rod, according to claim 1, characterized in that the indexing stop is incorporated to the rod of the connecting rod.

3. The connecting rod, according to claim 2, characterized in that the indexing stop is defined by at least one projection which projects from the rod in a direction transversal to the longitudinal axis of the latter.

4. The connecting rod, according to claim 3, characterized in that the indexing stop takes the form of a pair of projections, incorporated to opposite sides of the rod of the connecting rod and each defining an axial seating surface positioned at said predetermined distance in relation to the axis of the smaller eye of the connecting rod.
